(19) United States
(12) Patent Application Publication
(10) Pub. No.: US 2009/0128520 A1
(43) Pub. Date: May 21, 2009

(54) Use of physical media having the same position-identifying pattern in digital documentation production

(75) Inventor: Jean-Michel Combe, Grenoble (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/587,036

(22) PCT Filed: Jan. 25, 2005
(86) PCT No.: PCT/EP05/50354

§ 371 Date: Oct. 29, 2008

(30) Foreign Application Priority Data
Jan. 30, 2004 (GB) 0402018.6

(51) Int. Cl. G06F 3/033

(52) U.S. Cl. 345/179

(57) ABSTRACT

A method of producing an electronic document using a plurality of pieces of physical media having a common position location pattern marked thereupon, comprising the steps of: (i) marking a first piece of the physical media using a digital pen, said pen being arranged to acquire data to enable the determination of the location of a tip thereof upon physical media from the position location pattern marked thereupon; (ii) acquiring data relating to strokes and the location of the strokes of the pen upon the first piece of the physical media sequentially, and storing said data in a memory; (iii) acquiring data relating to strokes and the location of the strokes of the pen upon a second piece of the physical media sequentially, and storing said data in a memory; and (iv) arranging the data stored in steps (ii) and (iii) to form at least one electronic document in which the data relating to the first piece of physical media is distinguishable from the data relating to the second piece of physical media.

### FIELD OF THE INVENTION

This invention relates to a method, system and software for the use of physical media having the same position-identifying pattern in digital documentation production. More particularly, but not exclusively, the invention relates to a method, system or apparatus, and software for the use of multiple pieces of digital paper each having a common location identifier pattern printed thereupon.

### BACKGROUND TO THE INVENTION

Many digital pen and paper systems have been proposed. Few have been used on any commercial scale. One that is in use is the Anoto system, with their Logitech IO™ pen, available from Anoto Group AB. The invention will be described in relation to that kind of technology, and is especially, but not exclusively, applicable to arrangements where the pen sees a position-determining pattern that has been printed onto the page and in which an evaluation of the pen's position, and movements, is made using data collected by the pen, see for example www.anoto.com, or the published patent applications of Anoto.

Referring now to FIG. 1, a sheet of digital paper 100 has a position identifying pattern 102 is made up of a number of dots 104 arranged on an imaginary grid 106. The grid 106 can be considered as being made up of horizontal and vertical lines 108, 110 defining a number of intersections 112 where they cross. The intersections 112 are of the order of 0.3 mm apart. One dot 114 is provided at each intersection 112, but offset slightly in one of four possible directions up, down, left or right, from the actual intersection 112. The dot offsets, which are typically about 50 μm from the notional centre of the crossing grid “lines”, are arranged to vary in a systematic way so that any group of a sufficient number of dots 104, for example any group of 36 dots arranged in a six by six square, will be unique within a very large area of the pattern. This large area is defined as a total imaginary pattern space, and only a small part of the pattern space is taken up by the pattern on the sheet 100. By allocating a known area of the pattern space to the sheet 100, for example by means of a co-ordinate reference, the document and any position on the patterned parts of it can be identified from the pattern printed on it. An example of this type of pattern is described in WO 01/26033. It will be appreciated that other position identifying, or location, patterns can equally be used. Some examples of other suitable patterns are described in WO 00/73983 and WO 01/71643.

In current systems a different section of the very large pattern area is used on each piece of digital paper that is written on or annoted by a user using their digital pen. The user's pen sends details of the particular pen strokes it has made and the identity of the particular main sheet of digital (patterned) paper it made them on to an application server. The location of any group of dots upon a piece of digital paper is unique within the very large pattern space (which in one example could cover an area of about one third of the Earth's surface).

In the known Anoto-type arrangement a user has a pack or pad of digital, patterned, paper with each sheet of patterned paper having a unique position-identifying, or position-location, pattern on it. This has a number of disadvantages associated with it, for example, despite having a very large pattern area the available unique pattern will eventually become exhausted by the use of such systems. Typically, a supplier of digital paper will have acquired the right to use only a small fraction of the available from the controlling pattern space company (eg Anoto) unique pattern area and this will become exhausted rapidly as digital paper is supplied to users.

The current prior art systems works by clearing the pen's memory of the content once it has been sent to the application server. In one arrangement the digital pen is wirelessly-connected to an application server. In another, the pen is docked with a docking station at internals by the user. Because each page written by the user is on a separate uniquely identified page of location patterned paper, and because any small piece of pattern identifies not only the position of the pen on page, but also which page it is on, the server can resolve data that it receives into pages in the digital world that are equivalent to pages in the physical, real paper pages, world.

### SUMMARY OF THE INVENTION

According to a first aspect of the invention there is provided a method of producing an electronic document using a plurality of pieces of physical media having a common position location pattern printed, or otherwise marked, thereupon, comprising the steps of:
(i) marking a first piece of the physical media using a digital pen, said pen being arranged to acquire data to enable the determination of the location of a tip thereof upon physical media from the position location pattern printed, or otherwise marked, thereupon;
(ii) acquiring data relating to strokes and the location of the strokes of the pen upon the first piece of the physical media sequentially, and storing said data in a memory;
(iii) acquiring data relating to strokes and the location of the strokes of the pen upon a second piece of the physical media sequentially, and storing said data in a memory; and
(iv) arranging the data stored in steps (ii) and (iii) to form at least one electronic document in which the data relating to the first piece of physical media is distinguishable from the data relating to the second piece of physical media.

The first and second pieces of physical media may be sheets or pages, and the method may further comprises creating a page/division marker in pen-acquired data, for example by making a gesture with the pen upon the first page of physical media, indicative of termination of use of the front page of a document. The physical media may not be pages of paper, plastic film or the like: it could be surfaces of objects having more pronounced 3-D shapes, for example.

When the first and second pieces of physical media are sheets or pages the method may further comprise creating an electronic document marker in pen-acquired data by making a gesture with the pen upon a page, the gesture coding for an end of electronic document signal. The gesture may be ticking or crossing a box, or writing the word “END”, or some other gesture.

A user may write more than on electronic file/document on a single page of patterned paper (e.g. delineated, for example by the user ticking a “document complete” box between writing them). Alternatively, a user may write on more than one physical sheet of paper intending the user-added content to be a single electronic file/document and they may achieve that by not making a “document end” marker. They may, or may not, make “page end” markers within a single electronic document. They may or may not write or make “page end” markers at the end of writing each physical page, irrespective of whether they intend them to be stored as separate electronic/digital documents.

The method may comprise opening a second file in the memory associated with the second page pursuant to closure of the first file.

The data acquired in step (ii) may be stored in a short term memory in the pen initially and said data may be transferred to a protected, longer term, storage memory prior to the commencement of step (iii). The protected memory may be in the pen. The short term memory may be cleared before the commencement of step (iii).

The method may comprise associating a time stamp with the pen position relative to the pattern. Indeed, the 10 Logitec pen does already associate pen tip position with time, added by an on-pen clock, in order to assist in converting handwritten writing to typeface.

Pen-acquired data may be partitioned into different files prior to transmitting the data off-pen. The data stored in steps (ii) and (iii) may be transferred to a remote, off-pen processor unit prior to step (iv). Step (iv) may comprise arranging the data stored in steps (ii) and (iii) in order of the time stamp.

Preferably, the physical media comprises pages and the method comprises representing pen strokes made on the first piece of physical media digitally as a separate digital page from the digital representation of the pen strokes made on the second page, also represented as a digital page.

The method may comprise establishing a digital document division marker using the pen and the piece of physical media, the division marker being indicative of termination of use of a piece physical media upon the page of physical media to create a particular digital document. The method may comprise making a document division marker by making a pen stroke, and may further comprise registering the document division marker at a processor. The method may comprise creating the document division marker by making a tick or any other suitable predefined gesture of the pen upon the respective piece of the physical media. The method may comprise using time-related pen position data to establish document division or division point in captured data.

The method may comprise opening in a memory of a memory storage device (e.g. an on-pen memory device) a first file associated with the first piece of the physical media. The method may comprise closing the first file associated with the first piece of the physical media in response to registration of the document division marker by a processor controlling the allocation of date in the memory of the storage device. The method may further comprise opening a second file in the storage device associated with the second piece of the physical media, possibly upon closure of the first file.

The method may comprise storing the data upon a storage memory located upon the pen in steps (ii) and (iii).

The method may comprise transferring the data stored in steps (ii) and (iii) to a processor unit sequentially, typically in a first-in first-out (FIFO) manner, prior to step (iv). The method may comprise transferring the data off-pen to a remote processing unit, possibly for example via a wireless network or wired docking connection between the pen and the remote processing unit.

The method may comprise acquiring a time stamp with the data acquired in steps (ii) and (iii) representative of pen positions. The method may comprise transferring the data stored in steps (ii) and (iii) to a processor unit, prior to step (iv). Step (iv) of the method may comprise arranging the data stored in steps (ii) and (iii) in order of the time stamp. The time stamp may perform a page division or page end function, allowing a determination of when one page is ended and another is begun.

The first and/or second page data may contain data indicating the end of the first page and/or second page. The first and/or second page data may contain data indicating the start of the first or second page.

Data captured by a pen may indicate the start and/or end of a specific page of markings made by the pen upon a page of patterned material.

The separation of pen-acquired data that has been acquired from different pages of patterned material, each with the same pattern, into separate electronic documents equivalent to the separate pages can be performed in the pen, by an in-pen processor or at the off-pen processor.

The user may make a specific pen gesture which acquires data which codes for the end of a page, or the end of a document, causing an end of page or document marker to be encoded in the pen-acquired data.

Software may analyse pen-position with time data, without any specific end of page marker gesture being performed by the user to establish the end of a physical page or document.

A division of electronic data into separate pages or documents equivalent to the physical world may be performed pursuant to the identification in pen-acquired data of the end of a page, whether by virtue of identifying a marker or by virtue of analysis of pen-position-with-time data.

According to another aspect the invention comprises providing a digital pen adapted for use with a page of position-determining pattern, the pen having a pattern position capturer adapted to capture data relating to the position of the pen relative to a said pattern and adapted to store pen position data in a memory, and wherein the pen has a processor having software adapted to introduce a page or document end marker into pen-acquired pen-position data prior to storing the data in the memory.

According to another aspect the invention comprises providing a digital pen adapted for use with a page of position-determining pattern, the pen having:
a memory;
a pattern position capturer adapted to capture data relating to the position of the pen in relation to a said pattern and to store pen position data in a memory;
a clock adapted to produce time signals; and wherein
the pen has a processor having software adapted to associate time signals with the pen position data and to evaluate pen position with time to determine when a user has finished marking a physical first page and begins marking a second physical page having the same pattern, and to either:
(i) create a page end marker in the pen-captured data; or
(ii) store pen-acquired data from different physical pages, each having the same pattern, in different electronic files in the memory of the pen.

The processor may have software adapted to store pen-acquired data in a first memory of the pen and to transfer the data to a file in a second, protected, memory of the pen upon the determination of a page end. The processor may have software adapted to erase the first memory pursuant to transfer of pen-acquired data previously stored there to the protected memory. The processor may have software adapted to cause the pen-acquired data relating to successive physical pages, each having the same pattern, to be stored in either:
(i) the same file in memory; or
(ii) different respective files, one per physical page, in memory.

According to another aspect the invention comprises providing a digital document production system comprising a digital pen adapted for use with pages printed with a position-determining pattern, and an off-pen processor adapted to process data received from said pen; the pen comprising a writing tip, a position data acquirer adapted to acquire data relating to the position of the writing tip of the pen, a clock adapted to associate a time value with an acquired pen tip position, and an on-pen processor; at least one of the on-pen or off-pen processors being adapted to process data acquired by the pen writing on a first page having a position-determining pattern and data acquired by the pen writing on a second page having the same position-determining pattern in order to separate into different electronic documents data relating to markings made on the first page and markings made on the second page.

The pen may comprise a short term data storage memory and a long term data storage memory, the on-pen processor being arranged to store data corresponding to the first page, or a first electronic document, initially in the short term memory and to transfer first page data, or first electronic document data, to the long term memory device prior to storing data corresponding to the second page, or a second electronic document, in the short term memory.

One of the said processors may be adapted to recognise in the pen-acquired data a code coding for an end of page marker, and wherein a said processor may be adapted to store data acquired from different physical pages in different electronic files in memory using end of page markers to partition the pen-acquired data; and/or one of the said processors may be adapted to recognise in the pen-acquired data a code coding for an end of electronic document marker, and wherein a said processor is adapted to store data acquired before said end of electronic document code in one electronic document and data acquired after said end of electronic document code in a different electronic document.

One of the said processors may be adapted to use pen-position with time pen-acquired data to determine what pen-acquired data relates to which physical page. A said processor may be adapted to store pen-acquired data in separate files relating to separate physical pages pursuant to such a determination.

According to another aspect, the invention comprises providing software, optionally encoded upon a machine-readable storage medium, which when executed upon a processor causes the processor to:
(i) receive a first signal, indicative of the position of a pen upon a first piece of physical media having printed thereupon a position location pattern that is common with a second piece of physical media;
(ii) receive a second signal indicative of strokes, and the location of said strokes, of the pen upon the second piece of physical media; and
(iii) use the first and second signals to produce a digital document.

The software may cause the processor to separate data derived from the first and second signals into separate memory files.

According to another aspect the invention comprises providing a method of producing an electronic document using a plurality of pieces of digital paper having a common position location pattern printed thereupon, comprising the steps of:
(i) marking a first piece of the digital paper using a digital pen, said digital pen being arranged to acquire data from which it is possible to determine the location of a tip thereof upon digital paper from the position location pattern printed thereupon;
(ii) acquiring data relating to strokes and the location of the strokes of the digital pen upon the first piece of the digital paper sequentially, and storing said data in a storage device;
(iii) acquiring data relating to strokes and the location of the strokes of the digital pen upon a second piece of the digital paper sequentially, and storing said data in a solid state memory chip; and
(iv) arranging the data stored in steps (ii) and (iii) to form one or more electronic documents which represent the markings made on the physical pieces of digital paper in a matter such that the markings made on the first piece are separated from the markings made on the second piece.

According to another aspect the invention comprises providing a digital document production system comprising a digital pen suitable for marking digital paper having a position location pattern printed thereupon, and a computer;
the digital pen comprising a camera arranged to capture a first data set corresponding to strokes and the location of said strokes upon a first piece of the digital paper having a position location pattern printed thereupon, and a communication link arranged to place the camera and the computer in communication;
the camera being arranged to capture a second data set corresponding to strokes of the digital pen and the location of said strokes upon a second piece of digital paper, the second piece of digital paper having a position location pattern printed thereupon which is common with that printed upon the first piece of digital paper;
the computer being arranged to receive a data structure corresponding to said first data set and a data structure corresponding to said second data set; and;
the computer being arranged to decouple data structures corresponding to the first and second data sets to produce a digital document which has electronic equivalents to markings made on the first piece of digital paper separated from markings made on the second piece of paper; and wherein the computer is disposed either on the pen or off-pen.

According to another aspect the invention comprises providing a method of using the same digital pen readable position-determining pattern to create a digital document comprising marking a first material having a position-determining pattern provided on it with a digital pen and capturing first page data relating to pen movements on the first page;
marking a second page of material having the same position-determining pattern as the first page with the pen and capturing second page data relating to pen movements on the second page;
transmitting the first page data and the second page data to an on-pen or off pen processor; and
establishing from at least one of the first page data and/or the second page data which pen movements were made on the first page and which were made on the second page.

According to another aspect the invention comprises providing a digital pen adapted to acquire data representative of pen movement over a page, the pen having an optical position determining information capturing means adapted to view a position-determining pattern printed on patterned pages, and a computer memory, the computer memory containing data acquired by the information capturing means from a plurality of patterned pages, each having the same position-determining pattern on them, data from different pages being either:
(i) in separate files in the memory; or
(ii) delineated by page division markers acquired by the pen when transiting from one physical page to another.

According to another aspect the invention comprises providing an off-pen processor adapted to receive signals from a digital pen, the digital pen being adapted to acquire data relating to the position of the pen associated with time relative to a position-determining pattern, wherein the processor is adapted to receive from the pen signals containing pen position information relating to the use of the pen on a plurality of sheets of the same pattern, and wherein the processor is adapted to distinguish pen movements made on one sheet from pen movements made on another sheet either:
(i) by using time information to distinguish between movement of the pen on different sheets having the same pattern, or
(ii) by identifying sheet division marker codes included in the signals from the pen.

According to another aspect of the present invention there is provided a processor:
the processor being arranged to receive a first signal indicative of strokes, and the location of said strokes, of a pen upon a first piece of physical media having printed thereupon a position location determining pattern that is common with a second piece of physical media, the pen being arranged to acquire information from which it is possible to determine the location of a tip thereof from the position location pattern, and the processor being arranged to direct the first signal to a first storage device;
the processor being arranged to receive a second signal indicative of strokes, and the location of said strokes, of the pen upon the second piece of physical media, the processor further being arranged to direct the second signal to a first storage device.

The processor may be arranged to receive a signal a document division marker indicative of termination of use of the piece physical media upon the piece of physical media and may further be arranged to close a first file associated with the first piece of the physical media in response to receiving the document division marker. The processor may be arranged to open a second file at the storage device associated with the second piece of the physical media upon closure of the first file.

The processor may be arranged to control the transfer of data from the first storage device, which may be short term storage device, to a second, long term, storage device. The processor may be arranged to erase the contents of the first storage device following the transfer of data from the first storage device to the second storage device.

The processor may be arranged to time stamp at least some of the signals directed to the first storage device.

According to another aspect of the invention there is provided a digital pen comprising a processor according to the preceding aspect of the invention.

According to another aspect of the present invention there is provided a digital document production system comprising a pen suitable for marking physical media having a position location pattern printed thereupon, and processing means;
the pen comprising capture means arranged to capture a first data set corresponding to strokes and the location of said strokes upon a first piece of physical media having a position location pattern printed thereupon, and communication means arranged to place the capture means and the processing means in communication;
the processing means being arranged to receive a first data structure corresponding to said first data set;
the capture means being arranged to capture a second data set corresponding to strokes, and the location of said strokes, of the pen upon a second piece of physical media, the second piece of physical media having a position location pattern printed thereupon which is common with that printed upon the first piece of physical media; and
the processing means being arranged to receive second data structure corresponding to said second data set and to combine said data structures corresponding to the first and second data sets to produce a digital document.

According to another aspect of the present invention there is provided software encoded upon a storage medium which when executed upon a processor causes the processor to:
(i) receive a first signal, indicative of strokes and the location of said strokes of a pen upon a first piece of physical media having printed thereupon a position location pattern that is common with a second piece of physical media;
(ii) receive a second signal indicative of strokes, and the location of said strokes, of the pen upon the second piece of physical media; and
(iii) combine the first and second signals to produce a digital document.

The software may cause the processor to combine data entries within the first and second signals in the order that they are received.

The software may cause the processor to scan the first and second signals for time stamps associated with strokes of the pen upon the respective first and second pieces of physical media and extract said time stamps therefrom. The software may cause the processor to combine the first and second signals in a temporal sequence based upon the time stamps.

According to another aspect of the present invention there is provided a processor:
the processor being arranged to receive a first signal indicative of strokes, and the location of said strokes, of a digital pen upon a first piece of digital paper having printed thereupon a position location pattern that is common with a second piece of digital pen, the digital pen being arranged to arranged to determine the location of a tip thereof from the position location pattern, and the processor being arranged to direct the first signal to a first solid state memory chip;
the processor being arranged to receive a second signal indicative of strokes, and the location of said strokes, of the digital pen upon the second piece of digital paper, the processor further being arranged to direct the second signal to a first solid state memory chip.

According to another aspect of the present invention there is provided a digital pen comprising a processor according to the preceding aspect of the invention.

### BRIEF DESCRIPTION OF THE DRAWINGS

The invention will now be described, by way of example only, with reference to the accompanying drawings, of which:

FIG. 1 is a representation of a piece of prior art digital paper for use with at least one aspect of the present invention;

FIG. 2a is a representation of one embodiment of a digital document production system according to an aspect of the present invention;

FIG. 2b is a representation of an embodiment of a digital paper form;

FIGS. 3a to 3d are a series of representations of an embodiment of a digital pen according to at least an aspect of the present invention and a piece of digital paper operating in accordance with at least one other aspect of the present invention;

FIGS. 4a to 4d are a series of representations of a digital pen according to at least an aspect of the present invention and a piece of digital paper operating in accordance with at least one other aspect of the present invention;

FIG. 5 is a flowchart detailing a method of producing a plurality of electronic documents using physical media having a common position location pattern printed thereupon according to at least one aspect of the present invention; and

FIGS. 6A and 6B show features of memory organisation for different embodiments of the invention.

### DETAILED DESCRIPTION OF SOME EMBODIMENTS OF THE INVENTION

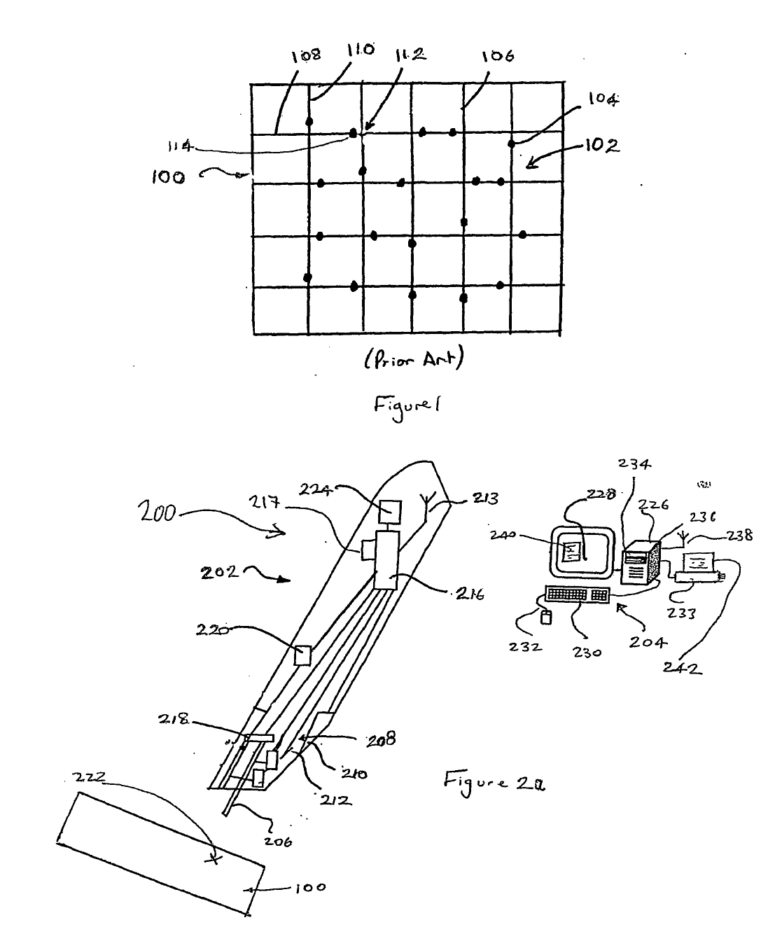

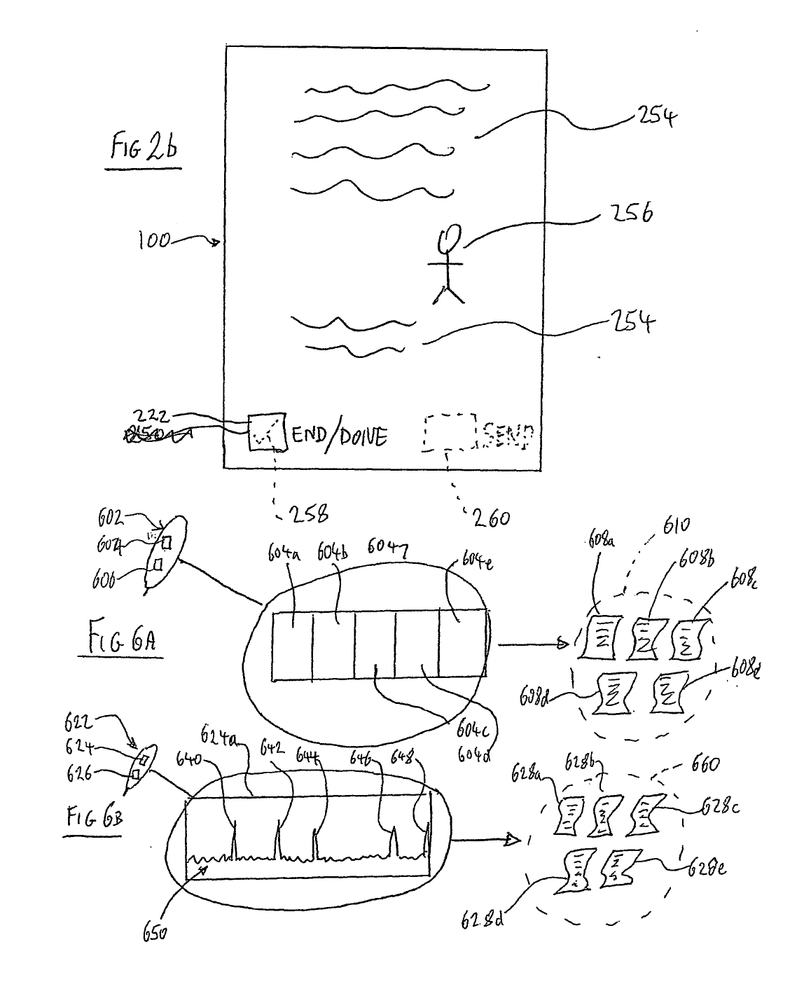

Referring now to FIGS. 2a and 2b, and also with reference to FIG. 1, a digital document production system 200 comprises a sheet of digital paper 100, a digital pen 202 and a computer 204, typically a PC.

The pen 202 comprises a writing stylus 206, and a camera 208 made up of an infra red (IR) LED 210, an IR sensor 212 and a wireless transmitter 213.

The camera 208 is arranged to image an area adjacent to a tip 214 of the pen stylus 206 and to capture images of the position identifying pattern. A processor 216 processes images from the camera 208. A pressure sensor 218 detects when the stylus 206 is in contact with the paper 100 and triggers operation of the camera 208. Whenever the pen 202 is being used on a patterned area of the paper 100, the processor 216 can therefore determine from the pattern 102 the position of the tip of the stylus 216 of the pen 202 whenever it is in contact with the paper 100 (whenever the camera 208 can see the pattern 102). From this can be determined the position and shape of any marks or strokes made on the patterned areas of the paper 100. The processing of pen position with time to establish what marks or strokes have been made on the paper can take place in the pen, or in the off-pen computer. The pen movement information is stored in a short term memory 220, for example RAM, in the pen 202 as it is being used. The pen 202 also has a clock 217 which provides a time associated with position-identifying signals from the camera 208, or alternatively associated with position-identifying signals post processing by the processor 216. The data that is stored in memory 220 has a timestamp associated with it so that the pen's position with time is determinable. When the user has finished marking the document this is recorded in a document completion process, for example, by making a document division, or completion, mark 222 with the pen 202 on the paper 100. The processor 216 is arranged to recognise document division, or completion, mark 222 and transfer the data in the short term memory to a protected long term memory 224 where the data is stored sequentially in order of arrival. This protected long term memory 224 is prevented from being over written until an explicit instruction to allow this is received from the processor 216. The data in the short term memory 220 is cleared once the data from the short term memory 220 is transferred to the long term memory 224 thereby enabling the pen 202 to be used with another piece of physical media, typically digital paper, having a position identifying pattern common with the first piece of digital paper 100 in order to create a new, different document, using the same area dot pattern.

A second sheet of paper having a position identifying, or determining, pattern common with the first sheet of paper 100 can then be written, drawn or otherwise marked using the pen 202 in similar manner as described hereinbefore with reference to the first sheet of paper 100. The termination of marking of the second piece of paper, typically by making a document division mark upon the second piece of paper results in data relating to the location a user's pen strokes upon the paper being transferred from the pen's short term memory 220 to the long term memory 224. This process can be repeated for many pieces of digital paper all having a common position identifying pattern upon them.

With reference to FIG. 2b, the completion of a document is typically signified by the marking of the a check box 222 provided on at least one of, or possibly all of, the sheets of digital paper, for example a check box marked “SEND”, although this need not be the case. Upon marking the SEND/END check box 222 the processor 216 controls the transmission of the data from the long term memory 224 via the transmitter 213 to the computer 204. FIG. 2b also shows content 252 added to the page 100 by the user using the pen 202, comprising writing 254 and drawings/sketches 256. A tick 258 is shown in dotted line in the box 272 to indicate what a user would do to indicate to the system that they had completed a particular document or page.

A page 100 may have both an “end” or “done” box or region 222 and a “send” or “document completed” box 260. If a user wanted to have a single electronic/digital document that required more than one page of paper 100 to create it they could write or draw on several pages of paper (each with the same position-determining pattern) and mark the “end” box 222 between each sheet (so that the system knows not to overlie markings from successive sheets) and then mark the send/document completed box 260 only when they wish to indicate to the system that they had finished the electronic document. There could be an “end page” instruction interface, and “end document” instruction, and “send document(s) previously accumulated” instruction, interfaces.

The transmission of the data occurs in this embodiment, but not necessarily in other embodiments, in the same sequence as the data was stored in the long term memory 224 of the pen 202, in a first-in first-out (FIFO) arrangement.

Alternatively, the transmission of the data from the pen's long term memory 224 to the computer 204 takes place at spaced apart time intervals, or when the pen 202 is in within transmission range of the computer 204, the pen 202 being able to poll the computer 204 to determine whether it is within transmission range.

As another example, the pen 202 may not have a wireless link to the computer 204: it may need to be physically docked in a docking station linked to the computer or otherwise wire-connected to the computer to transfer data to the computer 204.

The computer 204 comprises a processor unit 226, a visual display unit (VDU) 228, a keyboard 230, a mouse 232 and a printer 233.

The processor unit 226 comprises a central processor 234 such as an Intel Pentium processor, a data storage device 236, such as a magnetic hard disc or writeable digital versatile disc (DVD), and a wireless receiver 238.

The wireless receiver 238 receives data transmitted from the pen 202 via the transmitter 213. The data is then passed to the central processor 234, which has a digital documentation production software application running thereupon. The application can either concatenate the individual data files relating to each page of the document to form a single digital document 240 which is passed to, and stored upon, the data storage device 236 or it can store them still as separate files. The digital document 240 can be displayed upon the VDU 228 and, typically, can be edited using the keyboard 230 and mouse 232 in a conventional manner known to those skilled in the art. The digital document 240 can then be printed as a paper document 242 using the printer 233, or emailed, or otherwise treated as any other digital document.

Of course, if the digital document is only one page long there may be no need for the grouping/concentration of a number of digital pages.

Referring now to FIGS. 3a to 3d, with reference to FIGS. 1 and 2, a first embodiment of a pen 202 is used to write upon a piece of digital paper 100 in a manner know to those skilled in the art. A short term memory 220 within the pen 202 stores the current strokes of the pen 202 upon the sheet of paper 100. A box 302 upon the paper 100 is checked to signify that a user of the pen 202 has finished writing a page/making up a page using this particular piece of digital paper 100. Software in the processor 216 of the pen 202 responds to the marking of the box 302 by moving the contents of the short term memory 220 to a file in a protected, or long term, memory 224, also within the pen 202, where data relating to these previous strokes of the pen 202 is stored as a discrete file 304. The short term memory 220 is then purged to leave it clear for the next page of writing/marking. Alternatively, it may be possible to overwrite the short term memory, but at present it is considered better to clear it. Overwriting the short term memory may be feasible, as indicated, perhaps by using the time of recordal of data in the short term memory as a way of distinguishing new data from a new sheet of paper from old data from a previous sheet (if the new data is not as long/large as the old data and so does not cover all of it up in the memory).

A second piece of digital paper 100a, having the same location identifying pattern as the first piece of digital paper 100 (ie it is the same page of pattern in digital pattern space) is then written upon using the pen 202 in the conventional manner. The strokes of the pen upon the second piece of digital paper 100a are recorded in the short term memory 220 in the same manner as for the first piece of digital paper 100. Upon the user completing writing upon the second piece of paper 100a the user checks a box 302a and the contents of the short term memory 220 are transferred to the long term memory 224 as a discrete file 304a, different from the file 304. Each time that the box 202 is marked the pen stores the content added/recorded by the pen since the last marking of box 202 in a separate file in long term memory 224. The current strokes of the pen, applicable to a digital page being worked upon, are stored in the short term memory and then moved to the protected memory when the box 302 is marked. The discrete files 304, 304a, 304b relating to the pages of a digital document are stored in consecutive, sequential order dependent upon the time at which they were completed, each file typically containing an ordering indicia or marker such as time signature or a sequence number.

The pen 202 transmits the discrete files 304, 304a, 304b to the computer 204, typically via a wireless link, for example an IEEE 802.11, Bluetooth, Firewire or Ultra-Wide Band (UWB), link when the user tracks a “SEND” by on the sheet of paper. The processor of the computer 204 has a software application running thereupon which reads the ordering indicia (eg time signature or sequence number), from each discrete file 304, 304a, 304b and may order them to form a completed digital document which is stored in memory accessible to the computer 204 as a single fire/document, or it may continue to store at least some as discrete files.

The “send box” could be the box 302: this is to say the pen sends (or at least tries to send) data in its protected memory to the computer 204 as soon as each physical page is completed (as indicated/numbered by ticking the box 302. Thus the box 302 could serve to indicate the end of a page and to send the page to the computer remote from the pen.

Of course, the pen may not succeed in contracting the computer wirelessly and it may be necessary for the protected/memory of the pen to store more than one file (one page per file if the end box is the send box). Also, the processor of the pen could be arranged to save up a plurality of page files in its associated protected memory before trying to communicate with the remote computer.

The computer, in the embodiment of FIG. 3, receives a number of discrete files of data representing pen movements, each file containing the pen movements up until the indication of an end of page signal has been recorded by the pen.

If there are separate “end of electronic document” and “end of page” signal commands (e.g. separate check boxes on a digital form) a user can build-up a single electronic document in the pen's memory made up of user-applied content from a plurality of physical pages (see FIG. 2b).

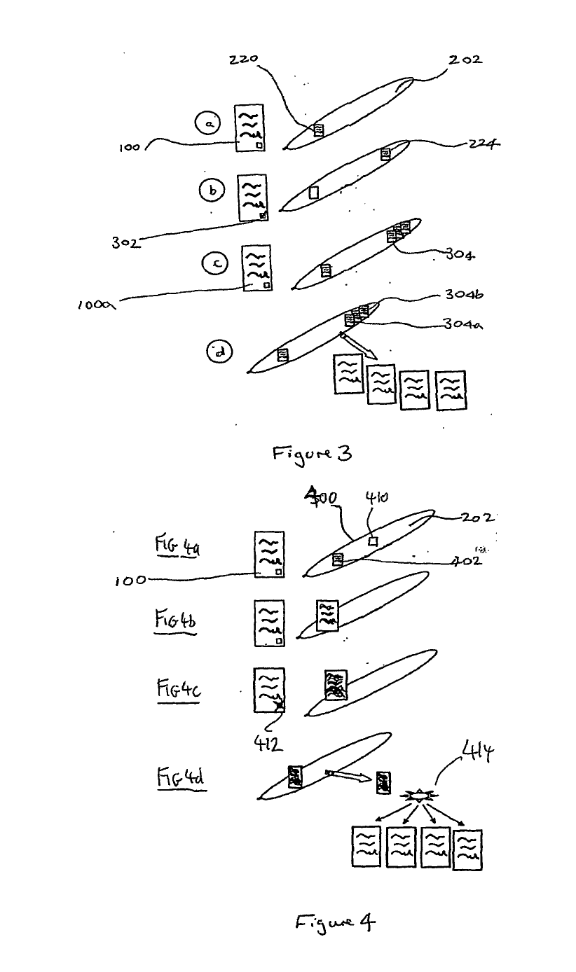

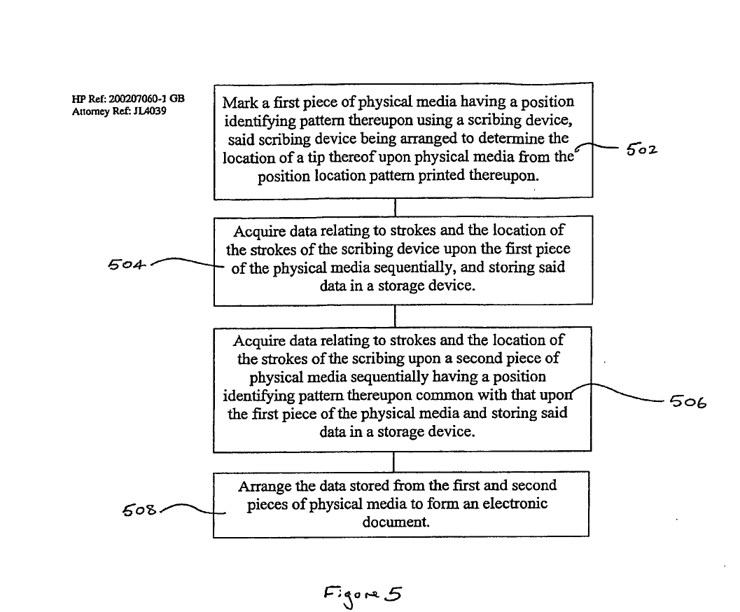

The embodiment of FIG. 3 uses the pen memory management system illustrated in FIG. 6A, described later.

It is possible at the application software end, at the remote computer off-pen, to combine one page files into a larger single electronic file containing the data from more than one page of paper.

With reference to FIGS. 4a to 4d, a different embodiment of the pen and off-pen application processor/computer is shown. In this example the pen has different software running on its processor 216. FIG. 4a shows schematically a pen 400 writing on a first sheet or form of digital, position determining patterned, paper and creating data in its memory, referenced 402 relating to pen strokes made on that first page of paper. The data relating to those pen strokes has encoded with it a time stamp indicating the chronological order of the pen strokes, the pen having a clock 410 in it to provide time information.

FIG. 4b shows a second page of pen writing using the pen 400, typically written on a second physical sheet of paper having the same dot-pattern (position-determining pattern) as the first sheet, and therefore coding for the same page in the user virtual, digital, pattern space. The second physical world page of writing/annotation is recorded in the same memory file of the pen as was the data for the first page.

FIG. 4c shows a third physical page of writing, and further pages of writing being recorded in the pens memory 402, along with the previous pages.

When a user has finished writing/using the pen and wishes to end a document that will be formed in the digital world they create a “document end” signal by, for example by checking an “END” or “SEND” by 412. As shown in FIG. 4d, the pen then sends the multi-page file (electronic file created using more than one page of digital paper) to a remote, off pen processor 414 which has software which is able to separate data relating to each physical page onto separate digital pages, possibly in a What You See Is What You Get (WYSIWYG) manner, or possibly using OCR or the like to turn hand writing onto typed text. It does this by using the time stamp data associated with the pen strokes.

Page separation software in the remote computer uses a combination of the time of making a marking and the position of the page of the marking to know when a user has gone from the bottom of one page to the top of another page. Possibly an algorithm to establish this as an interpretation of received data may also look at pen position for a period of time leading up to the jump in physical location on the page and/or following the jump in physical location. It would be desirable, for example in that way, to distinguish between an event where someone who has got to the bottom of a page has gone back to the top to correct something or add a few more words, from an event where a user starts a new page.

Of course, the embodiment of FIG. 4 may also have a “document finished” signal created by a pen stroke (eg ticking a “document finished” box). Thus multi physical page documents could be stored by the pen in a single file, the division between end of one file and the start of another being positively triggered by the user. This memory organisation is discussed in more detail alter in relation to FIG. 6b.

The pen 400 could store a plurality of multi page documents each in their own file, divided by the user marking a “document end” box, for example, or it could store different documents (data that is included by the user to be in different files (documents in the off-pen computer) in the same memory file to be divided into separate files off-pen using either time of strokes dependent analysis, or using user-applied file division markers in the data.

If a common position identifying pattern is used on more than one piece of digital paper the fact that a second, or subsequent, page had been started can be ascertained by reviewing the time stamp of entries associated with a common position identifying pattern and the pen stroke allocated accordingly. This is how the embodiment of FIGS. 4a to 4d operates.

Referring now to FIG. 5, a method of producing electronic documents using a plurality of pieces of physical media, having a common position location pattern printed thereupon, comprises using a pen to mark a first piece of the physical media (Step 502). The pen determines the location of a tip thereof upon physical media from the position location pattern printed thereupon, typically by means of a camera. Data relating to strokes and the location of the strokes of the pen upon the first piece of the physical media is acquired sequentially and stored in a storage device (Step 504). Data relating to strokes and the location of the strokes of the scribing upon a second piece of the physical media is acquired sequentially and stored in the storage device (Step 506). The data stored in the storage device is arranged to (Step 508) form an electronic document (Step 508), with the data relating to the first page being distinguishable from the data relating to the second page.

The method may include the user actually recording in the data acquired by the pen a page and/or file end marker.

The method may comprise the user not actively recording in the data acquired by the pen a page and/or file end marker, instead the method comprising using a knowledge of the time sequence of device captured data relating to device movements on one page of paper from device movements on another page of paper.

It will be appreciated that in a first class of embodiments the pen stores each electronic document that has been built up between the user ticking/gesturing/entering an electronic document division marker and the user entering a second electronic document division marker in a different electronic partitioned or divided part of its memory than it does other electronic documents that the pen has built up between other user-enterings of electronic document division markers: each electronic document (identified as such by the pen reading document division markers between electronic documents) is stored in its own protected memory (e.g. file) before transmission off-pen. This is illustrated in FIG. 6A. Pen 602 has a memory 604 and a processor 606. The processor 606 is adapted to recognise “end of document” signals (e.g. those input by a user moving the pen over an “end of document” command box on a page of digital paper), and puts each so identified electronic document into separate files 604a, 604b, 604c, 604d, 604e, in its memory 604. When the pen sends the contents of its memory to a remote off-pen processor, the processor receives separate files and can decide to store them as separate files 608a, 608b, 608c, 608d, 608e in an associated off-pen memory 610, or it can combine them into fewer electronic files.

It will also be appreciated that in a second class of embodiments the pen has a common digital memory containing electronic document proto-formers of a plurality of electronic documents (delineated by the insertion, using the pen, of document division signals into data relating to pen-written content added to pages upon which the pen has written), and the division of the larger electronic document that is stored in the pen memory into separate smaller electronic documents occurs off-pen, after the larger document has been transferred from the pen. This is illustrated in FIG. 6B. Pen 622 has a memory 624 and a processor 626. The processor 626 is not adapted to recognise “end of document” signals (e.g. those input by a user moving the pen over an “end of document” command input box and data acquired by the pen between data transfer operations from the pen to an off-pen processor is stored in a common memory file 624a. The “end of document signals” are schematically illustrated as peaks 640, 642, 644, 646, and 648 and will be used later to divide the single electronic document into separate electronic files/documents delineated by the end of document division markers 640-648 and store them in an associated off-pen memory 660 as separate documents 628a 628b, 628c, 628d, 628e. Once separated the electronic documents 628a to 628e can be recombined in any grouping and order the off-pen processor determines.

In a third class of embodiments, which can be considered a sub-class of either of the first or second classes of embodiments, the document division marker is not necessarily created by something the user has specifically done with the pen, but could be considered to be determined by software evaluating pen-position-with-time related data to establish a likely break/division between what were separate pages that a user has written on, or what were intended by the user to be separate electronic documents, and acting on that interpretation to separate a larger electronic document in a single memory partition (e.g. file) into a plurality of electronic documents in a plurality of separate memory spaces (e.g. files).

It will be appreciated that when we have said that a user writes on a first page of paper and then a second a subsequent page of paper, we mean both:
(i) that the user does just that—there are two or more different physical sheets of paper with the same position-determining pattern on them (and this is our preferred embodiment); and/or
(ii) that the second or subsequent pages of paper could be the same physical sheet of paper as the first page, the user overwriting the physical page (eg perhaps in a different colour, perhaps with same colour, or perhaps not leaving a visible trace of the pen movement at all).

An example of how the invention may be applied is given in the following scenario: a user is away from their PC or other computer but has a pad of, say, 20-50 sheets of Anoto-type position-determining pattern paper and a digital pen (eg the IO Logitec or the like). All of the pages in the pad have exactly the same position determining pattern on them to be used to capture the movements (writing or drawing) of the pen. This may avoid paying for more than one page of virtual, digital, pattern space. The user writes documents and stores them in any of the ways described, using any of the embodiments/software configuration described.

The pen-acquired data is transferred to the off-pen computer and is converted into separate files, one for each document. The association of data acquired from the operation of a particular pen on a particular specific page to create a particular digital file can be done either in-pen, or off-pen, as discussed.

If the user runs out of pages on their pad they can simply overwrite a page they have already used: the pen will not see it as a used page (the ink on the pen is typically transparent to the position-determining camera sensor—the dots are of course visible to the position-determining camera sensor).

It will be appreciated that by “pen” or “digital pen” we usually mean a device that can mark a page of paper with a human-visible marking, and again usually an elongate hand-held “pen”. However, to create a digital representation of pen-tip movements does not necessarily require actual visible marking to be made on a page, and “pen” should be interpreted in some embodiments to cover devices which are used like a pen but which do not actually leave visible markings. Perhaps they do not even contact the page surface.

It will be appreciated that in the examples discussed, the mechanism for giving command signals to the system is ticking command boxes (SEND, or END DOCUMENT), but that other ways of giving command signals are possible and envisaged. These include writing a gesture or word (e.g. when the word END is written and circles software in the pen or off-pen computer could interpret that as ending a page, or ending a particular document (e.g. if more than one document was written on the same physical page of paper); tracing a printed marking could be used (e.g. the user could trace with their pen a “send” signal marking, such as an arrow, printed next to the word “send”, possibly in a command panel printed on the paper form 100); or voice commands could be given to the pen (the pen having a microphone and voice recognition software being operable in the pen and/or off-pen processor).

It will be appreciated that the current IO Logitech pen already collects pen position with time data: but neither the existing pen, nor the existing off-pen processor, has software which analyses that data to distinguish markings made on two identical position-determining patterns from each other. In the existing IO Logitech system it is intended that each page of patterned paper has a unique pattern (no pages with the same pattern). If two pages with the same pattern were written on, the markings will be superimposed on the same virtual page, not identifiable automatically (either on-pen or off-pen) into two different electronic pages. We can do this by changing the software in the pen so that it splits the captured data into different electronic pages or files in the pen (the off-pen computer can then still use the existing off-pen application/marking processing software), or we can use the unmodified IO Logitech pen and change the software in the off-pen processor to decouple data relating to different physical pages that has been sent as one electronic document/file into separate electronic pages/files that are equivalent to the separate physical world pages/documents.

It is, of course, necessary to go directly against Anoto's “unique pattern per page” system to conceive of the solutions discussed.

1. A method of producing an electronic document using a plurality of pieces of physical media having a common position location pattern marked thereupon, comprising the steps of:
(i) marking a first piece of the physical media using a digital pen, said pen being arranged to acquire data to enable the determination of the location of a tip thereof upon physical media from the position location pattern marked thereupon;
(ii) acquiring data relating to strokes and the location of the strokes of the pen upon the first piece of the physical media sequentially, and storing said data in a memory;
(iii) acquiring data relating to strokes and the location of the strokes of the pen upon a second piece of the physical media sequentially, and storing said data in a memory; and
(iv) arranging the data stored in steps (ii) and (iii) to form at least one electronic document in which the data relating to the first piece of physical media is distinguishable from the data relating to the second piece of physical media.

2. The method of claim 1 wherein the first and second pieces of physical media are sheets or pages, and which method further comprises creating a page division marker in pen-acquired data by making a gesture with the pen upon the first page of physical media indicative of termination of use of the first page of a document.

3. The method of claim 1 or claim 2 wherein the first and second pieces of physical media are sheets or pages and which further comprises creating an end of electronic document division marker in pen-acquired data by making a gesture with the pen upon a page, the gesture coding for an end of electronic document signal.

4. The method of claim 2 or claim 3 comprising using a processor to identify the marker and closing a first file in memory associated with the first page or document pursuant to recognition of the page or document division marker.

5. The method of claim 4 comprising opening a second file in the memory associated with the second page or document pursuant to closure of the first file.

6. The method of any preceding claim comprising storing the data acquired in step (ii) in a short term memory in the pen initially and transferring said data to a protected, longer term, storage memory prior to the commencement of step (iii).

7. The method of claim 6 wherein the protected memory is in the pen.

8. The method of claim 6 or claim 7 comprising clearing the short term memory before the commencement of step (iii).

9. The method of any preceding claim comprising associating a time stamp with the position of the pen relative to the pattern.

10. The method of claim 9 wherein step (iv) comprises arranging the data stored in steps (ii) and (iii) in order of the time stamp.

11. The method of any preceding claim comprising partitioning pen-acquired data into different files prior to transmitting the data off-pen.

12. The method of any of claims 1 to 10 comprising transferring the data stored in steps (ii) and (iii) to a remote, off-pen, processor unit prior to step (iv).

13. A digital pen adapted for use with a page of position-determining pattern, the pen having a pattern position capturer adapted to capture data relating to the position of the pen relative to a said pattern and adapted to store pen position data in a memory, and wherein the pen has a processor having software adapted to introduce a page or document end marker into pen-acquired pen-position data prior to storing the data in the memory.

14. A digital pen adapted for use with a page of position-determining pattern, the pen having:
a memory;
a pattern position capturer adapted to capture data relating to the position of the pen in relation to a said pattern and to store pen position data in a memory;
a clock adapted to produce time signals; and wherein
the pen has a processor having software adapted to associate time signals with the pen position data and to evaluate pen position with time to determine when a user has finished marking a first physical page and begins marking a second physical page having the same pattern, and to either:
(i) create a page end marker in the pen-captured data; or
(ii) store pen-acquired data from different physical pages, each having the same pattern, in different electronic files in the memory of the pen.

15. A pen according to claim 13 or claim 14 wherein the processor has software adapted to store pen-acquired data in a first memory of the pen and to transfer the data to a file in a second, protected, memory of the pen upon the determination of a page end.

16. A pen according to claim 15 wherein the processor has software adapted to erase the first memory pursuant to transfer of pen-acquired data previously stored there to the protected memory.

17. A pen according to any of claims 13 to 16 in which the processor has software adapted to cause the pen-acquired data relating to successive physical pages, each having the same pattern, to be stored in either:
(i) the same file in memory; or
(ii) different respective files, one per physical page, in memory.

18. A digital document production system comprising a digital pen adapted for use with pages printed with a position-determining pattern, and an off-pen processor adapted to process data received from said pen; the pen comprising a writing tip, a position data acquirer adapted to acquire data relating to the position of the writing tip of the pen, a clock adapted to associate a time value with an acquired pen tip position, and an on-pen processor; at least one of the on-pen or off-pen processors being adapted to process data acquired by the pen writing on a first page having a position-determining pattern and data acquired by the pen writing on a second page having the same position-determining pattern in order to separate into different electronic documents data relating to markings made on the first page and markings made on the second page.

19. A system according to claim 18 wherein the pen comprises a short term data storage memory and a long term data storage memory, the on-pen processor being arranged to store data corresponding to the first page, or a first electronic document, initially in the short term memory and to transfer first page data, or first electronic document data, to the long term memory device prior to storing data corresponding to the second page, or a second electronic document, in the short term memory.

20. A system according to claim 18 or claim 19 wherein:
(i) one of the said processors is adapted to recognise in the pen-acquired data a code coding for an end of page marker, and wherein a said processor is adapted to store data acquired from different physical pages in different electronic files in memory using end of page markers to partition the pen-acquired data; and/or
(ii) one of the said processors is adapted to recognise in the pen-acquired data a code coding for an end of electronic document marker, and wherein a said processor is adapted to store data acquired before said end of electronic document code in one electronic document and data acquired after said end of electronic document code in a different electronic document.

21. A system according to any one of claims 18 to 20 wherein one of the said processors is adapted to use pen-position with time pen-acquired data to determine what pen-acquired data relates to which physical page, and wherein a said processor is adapted to store pen-acquired data in separate files relating to separate physical pages pursuant to such a determination.

22. Software, optionally encoded upon a machine-readable storage medium, which when executed upon a processor causes the processor to:
(i) receive a first signal, indicative of the position of a pen upon a first piece of physical media having printed thereupon a position location pattern that is common with a second piece of physical media;
(ii) receive a second signal indicative of strokes, and the location of said strokes, of the pen upon the second piece of physical media; and
(iii) use the first and second signals to produce a digital document.

23. Software according to claim 22 which causes the processor to separate data derived from the first and second signals into separate memory files.

24. A method of producing an electronic document using a plurality of pieces of digital paper having a common position location pattern printed thereupon, comprising the steps of:
(i) marking a first piece of the digital paper using a digital pen, said digital pen being arranged to acquire data from which it is possible to determine the location of a tip thereof upon digital paper from the position location pattern printed thereupon;
(ii) acquiring data relating to strokes and the location of the strokes of the digital pen upon the first piece of the digital paper sequentially, and storing said data in a storage device;
(iii) acquiring data relating to strokes and the location of the strokes of the digital pen upon a second piece of the digital paper sequentially, and storing said data in a solid state memory chip; and
(iv) arranging the data stored in steps (ii) and (iii) to form one or more electronic documents which represent the markings made on the physical pieces of digital paper in a matter such that the markings made on the first piece are separated from the markings made on the second piece.

25. A digital document production system comprising a digital pen suitable for marking digital paper having a position location pattern printed thereupon, and a computer;
the digital pen comprising a camera arranged to capture a first data set corresponding to strokes and the location of said strokes upon a first piece of the digital paper having a position location pattern printed thereupon, and a communication link arranged to place the camera and the computer in communication;
the camera being arranged to capture a second data set corresponding to strokes of the digital pen and the location of said strokes upon a second piece of digital paper, the second piece of digital paper having a position location pattern printed thereupon which is common with that printed upon the first piece of digital paper;
the computer being arranged to receive a data structure corresponding to said first data set and a data structure corresponding to said second data set; and;
the computer being arranged to decouple data structures corresponding to the first and second data sets to produce a digital document which has electronic equivalents to markings made on the first piece of digital paper separated from markings made on the second piece of paper; and wherein the computer is disposed either on the pen or off-pen.

26. A method of using the same digital pen readable position-determining pattern to create a digital document comprising marking a first material having a position-determining pattern provided on it with a digital pen and capturing first page data relating to pen movements on the first page;
marking a second page of material having the same position-determining pattern as the first page with the pen and capturing second page data relating to pen movements on the second page;
transmitting the first page data and the second page data to an on-pen or off-pen processor; and
establishing from at least one of the first page data and/or the second page data which pen movements were made on the first page and which were made on the second page.

27. A digital pen adapted to acquire data representative of pen movement over a page, the pen having an optical position determining information capturing means adapted to view a position-determining pattern printed on patterned pages, and a computer memory, the computer memory containing data acquired by the information capturing means from a plurality of patterned pages, each having the same position-determining pattern on them, data from different pages being either:
(i) in separate files in the memory; or
(ii) delineated by page division markers acquired by the pen when transiting from one physical page to another.

28. An off-pen processor adapted to receive signals from a digital pen, the digital pen being adapted to acquire data relating to the position of the pen associated with time relative to a position-determining pattern, wherein the processor is adapted to receive from the pen signals containing pen position information relating to the use of the pen on a plurality of sheets of the same pattern, and wherein the processor is adapted to distinguish pen movements made on one sheet from pen movements made on another sheet either:
(i) by using time information to distinguish between movement of the pen on different sheets having the same pattern, or
(ii) by identifying sheet division marker codes included in the signals from the pen.
